(19) United States
(12) Patent Application Publication
(10) Pub. No.: US 2009/0092443 A1
(43) Pub. Date: Apr. 9, 2009

(54) Breach resistant composite barriers

(76) Inventors: Keith Friedman, Santa Barbara, CA (US); D. Erich Weerth, San Jose, CA (US)

Correspondence Address: MARK RODGERS, 1590 SAN ROQUE ROAD, SANTA BARBARA, CA, 93105, US

(21) Appl. No.: 12/148,435

(22) Filed: Apr. 17, 2008

Related U.S. Application Data
(63) Continuation-in-part of application No. 11/501,981, filed on Aug. 9, 2006, now abandoned.

(51) Int. Cl. E01F 13/12; B32B 27/12; B32B 3/12; B32B 3/00

(52) U.S. Cl. 404/6; 428/300.7; 428/116; 428/172; 442/181; 404/72

(57) ABSTRACT

This invention is a novel system for resisting barrier breach resulting from kinetic energy (i.e. ramming impacts). It consists of lightweight, sectional or continuous barriers made of a breach resistant fiber reinforced polymer resin matrix composite, which may be fabricated on site. The barriers are lightweight and thin enough that they may be used in many spaces where barriers made from conventional construction materials are impossible, impractical, or undesirable.

### RELATED APPLICATIONS

This application is a continuation in part of application Ser. No. 11/501,981, filed Aug. 9, 2006

### FEDERALLY SPONSORED RESEARCH

Not Applicable

### SEQUENCE LISTING

Not Applicable

### BACKGROUND OF THE INVENTION

The invention relates to protection of structures or other assets from surface level battering ram impact threats. The invention is particularly suitable for protecting buildings from car or truck bombs such as may be used in attempting to ram and/or breach the perimeter wall protecting an important building or valued asset.

One common, worldwide method used by terrorist organizations is to use a bomb which is installed in a car, truck or other vehicle. The vehicle is driven adjacent to a target, and the bomb is then detonated in close proximity to the target. Examples of such attacks are the Oklahoma City federal building incident, the attack on the marine base in Beirut, multiple examples of IRA operations, and more recently a series of attacks on foreign interests in Saudi Arabia and the nightclub bombing in Bali. Where perimeter walls or barriers are employed a distance away from the target, a terrorist vehicle or truck (with or without explosives) may be used to ram and/or breach the perimeter wall. This then allows another bomb carrying vehicle to drive through the breached wall to gain closer access to the target. Clearly, vehicle bombing is employed for destructive ends by a wide variety of terrorist organizations all over the world.

However, existing means of preventing access are very difficult to use to protect most sites. Steel or concrete barriers must be extremely massive to be effective and are difficult to install by virtue of their excessive weight. Extremely thick, heavy barriers are very difficult and time consuming to prefabricate, transport and erect, making it impractical to provide breach resistant protection from vehicle threats to existing buildings. Finally massive barriers are not aesthetic and architecturally harmonious with the vast majority of sites. Having to mar the appearance and functionality of sites to protect them from terrorism can be considered a victory for the terrorist in and of itself. Clearly, a more practical means of surface level anti-ram breach protection would be an important tool in the struggle against world-wide terrorism. The present invention provides a superior approach to anti-ram or anti-breach site protection.

### BRIEF SUMMARY OF THE INVENTION

The invention is a breach resistant protection barrier. Such barriers may include an above and below ground portion constructed entirely or in part of a breach resistant composite, where the below ground portion anchors the barrier. The construction is preferably a fiber reinforced polymer (FRP) matrix composite laminate of novel characteristics, described herein. The barrier may also include external bracing, either angular, linear or curved. Such barriers include three distinct categories. Category I includes PERMANENT barriers which are embedded into the ground at an appropriate embedment depth. These types of barriers are intended to be permanent installations. Category II barriers are SEMI-PORTABLE barriers which exhibit low soil embedment (typically less than 2 ft [0.608 m]) thereby allowing slight excavation for removal and transport of the barrier to a new location. Finally, Category III includes completely PORTABLE barriers which rest on the ground with no soil embedment. They may or may not have the capability of being ballasted with sand or water and in such cases would require drainage of any sand or water ballast before transport of the barrier to a new site location.

In a preferred embodiment the barrier consists of sectional elements, arranged to form a pattern. Where anti-climb is a requirement, one version of the pattern is, at least in part, the sectional elements arranged to form a continuous wall. In another version not requiring anti-climb, the pattern is, at least in part, the sectional elements arranged to form a labyrinth or maze.

In another embodiment where anti-climb is not required, the sections may be colored and/or shaped to provide aesthetic and architectural value. Sections with curved shapes, both vertical and/or horizontal curved shapes, are contemplated.

In one embodiment the barrier is a composite laminate made from several layers or plies which make up the entire barrier thickness. The layers may be oriented at different angles with respect to one another. Each layer may utilize different fiber architectures, including but not limited to woven fabric, unidirectional tape, stitched reinforcement, or knitted reinforcement.

In a further embodiment, the barrier is a sandwich construction, of which at least one layer is a composite FRP laminate and at least one layer is a core material. The core material in the sandwich may include but not be limited to, opened or closed cell foam, a honeycomb material, nomex, embedded I-beams of varying materials, or embedded composite pultrusions of constant cross-section along the length of the pultrusion.

In a further embodiment, the barrier is a hybrid laminate where part of the laminate total thickness uses one type of composite laminate and the other part of the thickness uses a different type of composite laminate.

In a further embodiment, the barrier is a hybrid laminate utilizing different composite material plies or layers from one layer to the next in an inter-leaved fashion.

In a further embodiment for tall walls which are also intended as anti-climb walls, the lower portion of the wall is of composite construction, whereas, the upper portion of the wall (where the wall bending moment is small) could be made using other materials, including but not limited to continuous compression molded or pultruded caps to further reduce weight and cost. The thickness of the barrier may vary, with the thickest portion being at the point of maximum moment arm due to ramming, typically ground level. Other parts of the barrier may be thinner or assume other shapes either for appearance or for functionality, such as anti-climb characteristics.

Another embodiment of the invention is a method of constructing a breach resistant barrier on site. The method includes providing a controlled environment at or near the site requiring breach protection, and providing a tool which allows for forming of barrier sections and producing and curing sections in the controlled environment. The sections produced in the controlled environment may then be used to erect a barrier pattern at the construction site.

In a further embodiment of the method, the controlled environment is an air conditioned enclosure in which at least temperature and humidity are controlled. In a preferred embodiment of the method, the sections are constructed at least in part using a fiber reinforced polymer matrix composite. For the composite, resin may be added using a resin infusion process where the dry layers of reinforcement are vacuum bagged. In a further embodiment of the method, the reinforcing fiber is pre-impregnated.

In another embodiment, the invention is used for protection against low to moderate velocity projectiles, debris or fragments. Such low to moderate velocity projectiles, debris or fragments may be the result of tornadoes, hurricanes or other natural disasters, as well as human acts of violence.

### BRIEF DESCRIPTION OF THE DRAWINGS

The detailed description of how to make and use the invention will be facilitated by referring to the accompanying drawings.

FIG. 1 shows a Category I breach resistant barrier according to the invention where H₂>2 ft (0.608 m).

FIG. 2 illustrates a novel Category I barrier without bracing just prior to a breaching attempt by a truck impacting the barrier normal to the barrier surface.

FIG. 3 illustrates the action of a novel Category I barrier in response to the breaching attempt, where the total kinetic energy (KE) of the vehicle is absorbed by truck deformation, barrier bending deformation and soil deformation.

FIGS. 4a, 4b and 4c illustrate examples of Category II low embedment depth, semi-portable composite barriers.

FIGS. 5a and 5b illustrate examples of no embedment, Category III portable composite barriers.

FIGS. 6a-6e illustrate various cross-sectional construction versions of the novel barrier.

FIG. 7 illustrates composite panels installed in the field which may include a vertical joint (i.e. slit) between adjacent panel sections.

FIG. 8 illustrates a method for construction of the novel barriers.

### DETAILED DESCRIPTION OF THE INVENTION

The inventors have produced a new concept for providing breach protection against vehicles or any other object that may be used as a battering ram, enabled in part by employing very different materials than currently used for this application. Current materials used for this application are primarily reinforced concrete, masonry, aluminum, steel or timber. Conventional materials have compressive strength properties which are inadequately low to effectively resist the breaching of a wall or barrier subjected to a high kinetic energy impact e.g. vehicle ramming. A large amount of conventional material is required to stop a high kinetic energy moving mass. Thus barriers made of these materials are massive, heavy and expensive to transport and/or install. A new class of materials enables a different approach. Such materials are similar to fiberglass in that they utilize a reinforcing fiber architecture which is infused with a polymer resin matrix. In order for the FRP composite laminate to be breach resistant it must be a structural laminate (rather than a low resin content ballistic laminate) capable of developing its full flexural strength such that the laminate is able to bend without breaking. The most effective version of composite construction utilizes materials which exhibit high compressive and tensile specific strengths and high compressive and tensile specific moduli. Specific strength is defined as the ultimate compressive (or tensile) strength of the material divided by its density. Specific modulus is the elastic compression (or tensile) modulus of the material divided by its density. The polymer resin matrix is resistant to galvanic corrosion, solvents and chemical agents. These materials exhibit much higher resistance to breaching per unit volume than masonry, reinforced concrete, aluminum, steel or wood. The specifics of the novel material are described below. A co-pending application by the inventor of this application describes the use of such material for explosive blast protection barriers. This application is incorporated by reference in its entirety.

Composite materials have been used for ballistic protection, such as in projectile-resistant armor. The ballistic resistant scenario requires that the composite resist spreading to complete failure as the projectile penetrates the material. As is known in the art, this result has been achieved by producing materials with a low resin content by weight. Such materials, although resistant to spreading, are weak structurally, ie they have low flexural strength. Thus these materials are generally used as a projectile-resistant layer over a structural base, such as a composite layer applied to steel in a military vehicle.

Conversely, penetration resistance, like blast resistance, requires very high structural strength, well above the intended-use load bearing requirements for conventional composite structures such as boat hulls, car bodies and the like. The inventors have discovered that orienting a portion of the fibers in a direction along the greatest anticipated flex axes, along with a much higher resin content by weight than used in conventional composites, results in a useful degree of penetration resistance in a sufficiently thick composite structure. The inventors have produced 2″ thick (8′ H×10′ L) composite panels with flexural bending strength of over 100,000 PSI in standard 3-point flexural tests without exhibiting premature splitting shear failure as a first ply failure mode. Such performance is believed adequate for many breech resistant applications. Such a structure would clearly also provide a degree of ballistic protection simply due to thickness, and as will be shown below, for certain formulations of the composite, the fibers may be treated in such a way that increases resistance to projectile spreading without losing structural strength. Such panels are a useful size to serve as sections of penetration resistant barriers with a significant weight savings compared to concrete or steel barriers in addition to other significant beneficial characteristics, thereby demonstrating the applicability of the novel FRP composite structure as a penetration barrier.

The fiber orientation for a breech resistant barrier preferably is oriented along the bending axes anticipated, which for a barrier embedded in the ground are the vertical and horizontal axes. Controlling weave geometry to achieve alignment in multi layer laminates is not a requirement for existing composite applications, which is one reason existing composites are not effective breach barriers. To achieve the desired novel construction, weave has to be procured with at least a portion of the fibers at a given orientation, and then the weave has to be applied to maintain that orientation as each ply is built up, up to 40 or more plies. Although a range of fiber orientations will deliver useful results, the inventors have found that a 50% vertical, 50% horizontal fiber weave is near optimum for a breach barrier application, while as little as 25% oriented along the vertical and horizontal directions is still beneficial, although variation around this weave will provide useful results. In order to make a thick laminate, 2″ or more, several layers of fiber weave are needed, close to 40 for some tested versions the inventors have produced. The inventors have also found that fiber weight per layer greatly affects the amount of resin which can be carried by the laminate. Therefore one parameter necessary to achieve the required resin content is fiber weight per layer. A Fiber Area Weight FAW in the mid 50 oz./sq. yd. range has been found effective The inventors have to date made panels using E-glass fiber. S2-glass is also a possibility, more expensive but less thickness and weight for the same flexural strength. The use of S2 glass also allows for the treatment of the fibers with sizing agents that increase the fiber-resin bond, and give the composite better resistance to significantly better ballistic penetration with some reduction in flexural strength. An example of such a sizing agent is Gamma-Aminopropyl Triethoxysilane

As described in the co-pending application there is a strong dependence of flexural strength on resin content percentage. Greater than 28%, and ideally 29-30% is required. Such resin content is not common, and the inventors have identified several process parameters to achieve such high resin content, using a vacuum infusion process. First the resin viscosity for a suitable resin such as a vinyl ester for E2 glass should be relatively low to allow for adequate wet-out through the thick ply structure. A rule of thumb is that the resin should fully drain from a resin test cup, as known in the art, in 35 minutes or less. Also an inhibitor, such as Hydroquinone should be used to delay resin gellation until full ply wet-out is achieved. The inhibitor should be added sufficient to delay gellation until at least 20 minutes after the panel form is completely filled. A resin suppler can be asked to determine inhibitor/catalyst/resin concentrations for a given form volume and desired fill-time. Finally the temperature should be controlled of the resin during fill to assure that gellation is achieved before resin is pulled by the vacuum system. Thus monitoring the pull-line for resin and increasing the fill temperature if necessary to keep resin from pulling before full gellation also contributes to higher resin content. The combination of the proper choice of ply weight, resin viscosity, inhibitor/catalyst concentration, and control of fill/gellation time achieved resin contents of over 29%, and panels of very high flexural strength. It has also been found that adding A-glass veil layers to each ply helping resin take-up. The veils are less than 10% of the mass of the fibers in the material, comprised of highly uniform, randomly distributed filaments bonded with a soluble thermoset polyester.

A specific example of a panel which achieved flexural strength of approximately 100,000 psi is described. The panel was made of an E-glass/Vinyl Ester thick laminate of thickness 2″, exhibiting an E-glass fiber content of at least no more than 71% by weight. The number of plies of reinforcement was approximately 39. In order to maximize the structural load bearing capability of the blast resistant FRP laminate, the fiber reinforcement had a vinyl ester compatible surface treatment in order to maximize the fiber-to-resin bond strength. The FRP blast panel was fabricated using the Vacuum Infusion Process (VIP) achieving at least 29% by weight and a cured laminate void content of less than 0.5% by volume. A pre-catalyzed vinyl ester resin was used to infuse the panel. The glass transition temperature of the resin, as measured by Dynamic Mechanical Analysis (DMA), was least 290° F. in order to withstand extreme hot and cold operating service temperatures. The viscosity of the resin was less than 230 cps at 77° F. in order to accomplish full and complete wet-out of all reinforcing fibers during vacuum infusion. The resin gellation time was less than 110 minutes in order to avoid polymerization of the resin prior to achieving complete wet-out of the reinforcing fibers. The FAW of the fiber plies was 55.53 oz/sq yd. In one version, each ply included an A-glass veil, 10 mils thick with FAW of 10.8 oz/sq yd.

The inventor's novel version of such a composite provides breaching protection equal to more than 6 inches (15.24 cm) of doubly reinforced concrete with a thickness of 2 inches (5.08 cm.). A 10′ by 10′ by 2″ (3.05 m by 3.05 m by 5.08 cm) section of the composite breach resistant material will weigh approximately 2,059 lbs (936 kg). A 10′ by 10′ by 6 inch (3.05 m by 3.05 m by 15.24 cm) section of reinforced concrete requires more than three times as much space and weighs 7,920 pounds (3,600 kg). Such a thickness of reinforced concrete is highly susceptible to spall formation when subjected to blast loading and is therefore not a practical solution to protect a building in close proximity to streets and sidewalks. The size and velocity of concrete spall fragments which are hurled toward the building can be more dangerous and devastating to the building and personnel survivability than the explosive blast overpressure had there been no reinforced concrete wall present at all. Moreover, the size and weight of traditional barriers makes for extremely difficult and time consuming installation. Clearly barriers of the composite type enable a much wider range of options to protect a site against a surface level attempt to breach such a barrier.

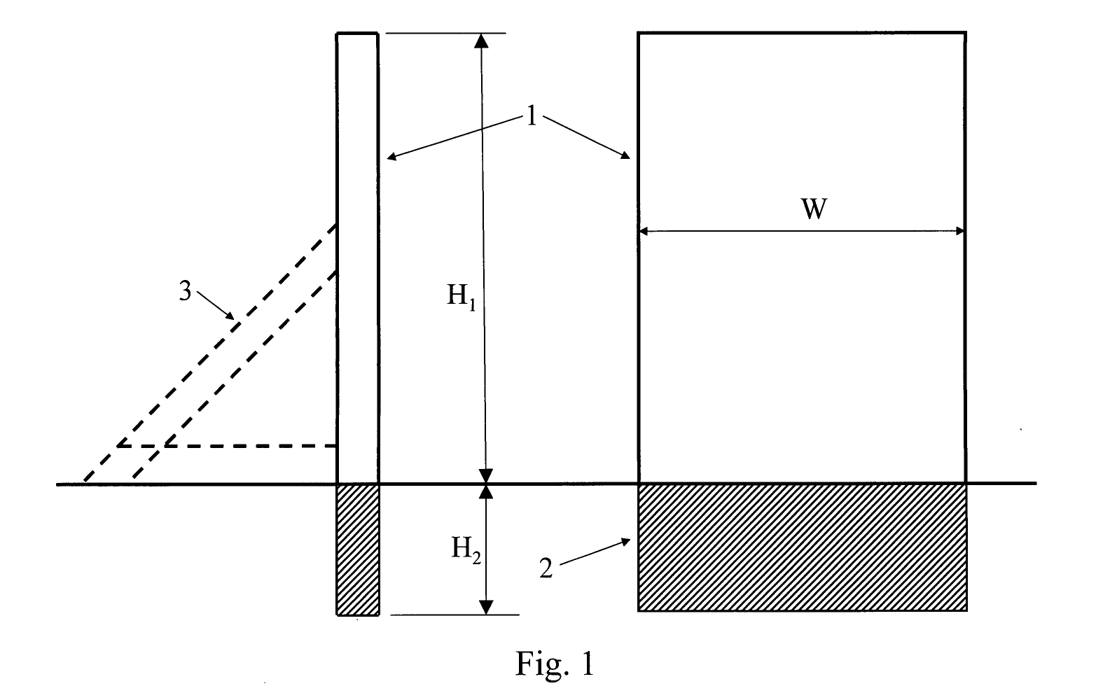

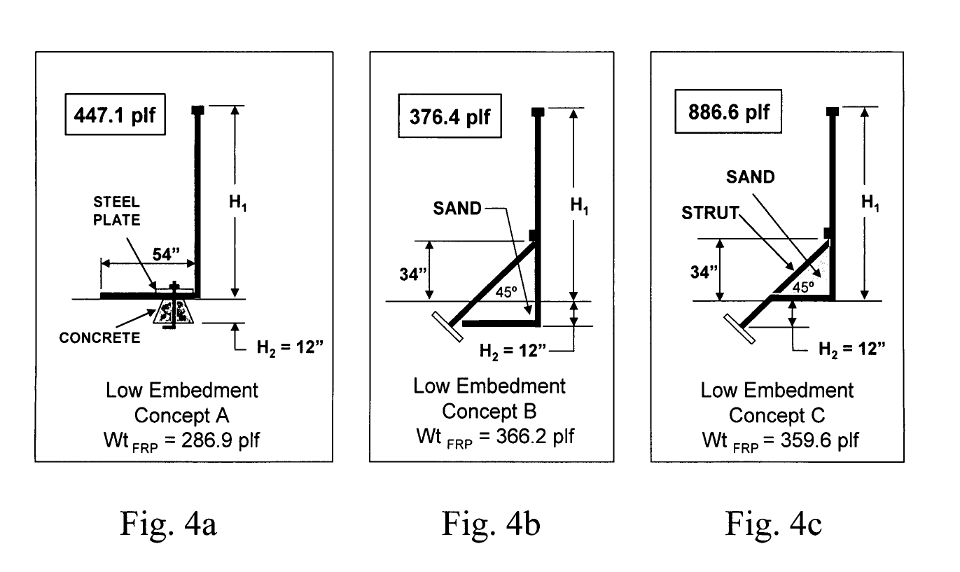

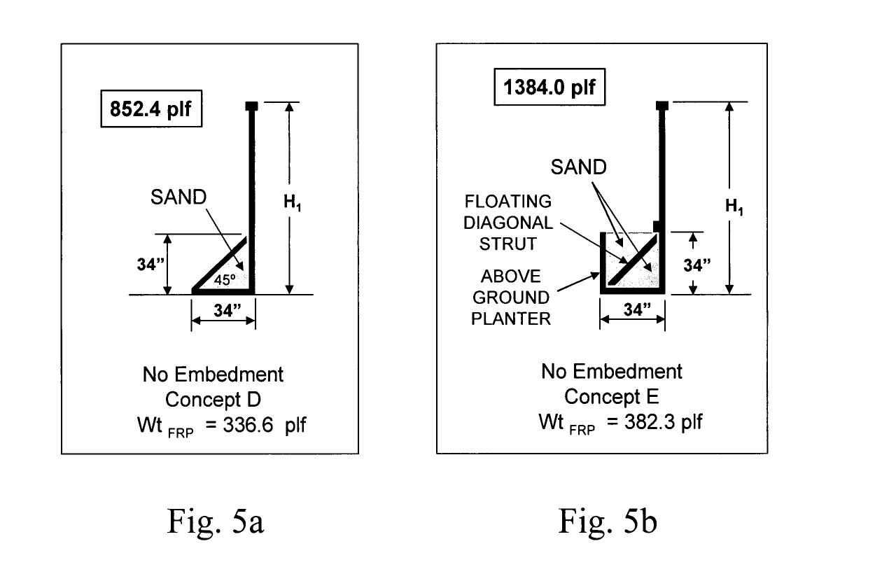

Referring to FIG. 1, a preferred implementation of the invention is shown. A section of a breach resistant barrier 1 consists of a portion H₁ above the ground 2 and a portion H₂ below ground. For a permanent Category I barrier, H₂ is typically greater than [symbol] 24 inches (0.608 m). The composite barrier panels may be constructed and assembled as a continuous wall. The above ground portion is at least partially constructed of a composite of the type described above. The below ground portion, which anchors the section against the attempted breach, does not have to be of composite construction. It may, however, be preferable to use a composite material below ground since the composite material is non-biodegradable and such an approach is contemplated by the invention. The above ground portion may be a variety of shapes. Although the invention is not constrained by the actual dimensions, the inventor has found that for anti-climb applications, a wall height, H₁, of 9 ft (2.743 m) or higher, a height, H₂, of 5 ft (1.524 m) and a width, W, of 8 ft (2.438 m) is suitable for shipping and handling. Such dimensions allow for a manageable number of sections to surround a building, enough height to protect against anti-climb and truck impact, and a weight of less than 1.2 tons (1.05 metric tons) which is easily handled by small scale construction equipment and small work crews. The panels may be installed by butting adjacent panels side-by-side leaving an unjoined vertical seam (i.e. slit) between neighboring panels. A top cap may be used to connect neighboring panels along the top edge of the wall. The top cap serves two purposes, namely, (1) to align panels along the wall length and (2) to transfer i.e. distribute the impact load to adjacent wall panels along the length of the wall. The composite material exhibits an extremely large energy absorbing capacity per unit volume. Typically, the limit of a barrier's ability to withstand a ramming object's mass and speed will also depend a great deal on the barrier's ability to effectively transfer kinetic energy into the ground i.e. soil, while simultaneously preventing rupture or overturning of the barrier. For larger threat scenarios, it may be advantageous to increase the barrier's ability to withstand breaching by increasing H₂ or by adding additional bracing 3 (either cross or horizontal or both) as shown in FIGS. 1, 4 and 5. Examples of both low embedment, Category II and no embedment, Category III barrier installations are shown in FIGS. 4 and 5, respectively, with weights shown in pounds per linear foot (plf) of a 10 ft (3.048 m) high barrier for each example.

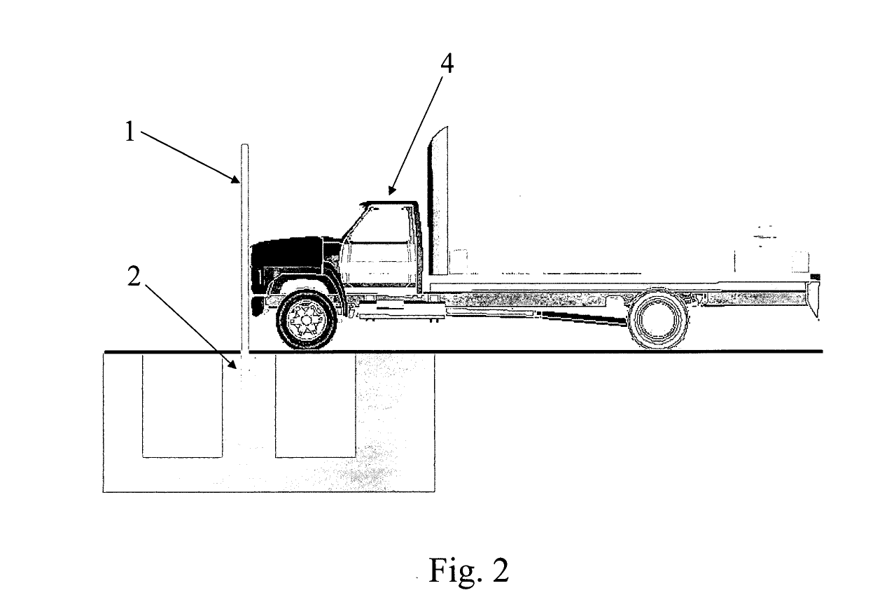

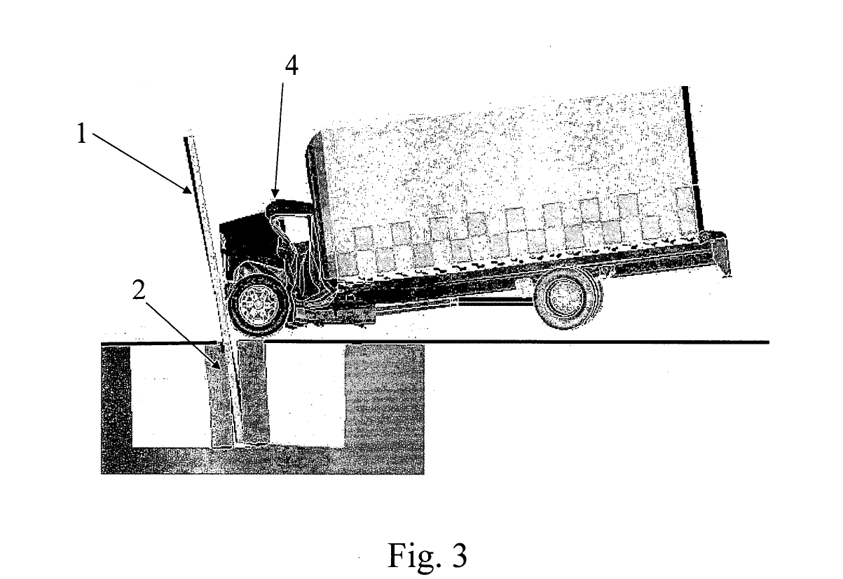

FIG. 2 shows a novel breach resistant barrier in action. Truck 4 is shown attempting to breach the barrier 1, embedded into the ground i.e. soil 2. All elements are shown, the threat, the above and below ground barrier sections and the soil embedment into the ground. Referring to FIG. 3, the dynamic response of the barrier is shown. The barrier exhibits elastic response (i.e. recoverable behavior) during and subsequent to truck impact and remains intact. The entire kinetic energy of the 6,818 kg (15,000 pound) truck traveling at a speed of 80 km/h (50 mph) is absorbed by elastic bending of the composite barrier, plastic deformation of the truck and movement (i.e. compaction) of the soil. A 2 inch (5.08 cm) wall of the type described can withstand a kinetic energy of 1.25E6 ft-lb (1.70E6 Joules) and exhibit entirely elastic response without a breach of the composite barrier.

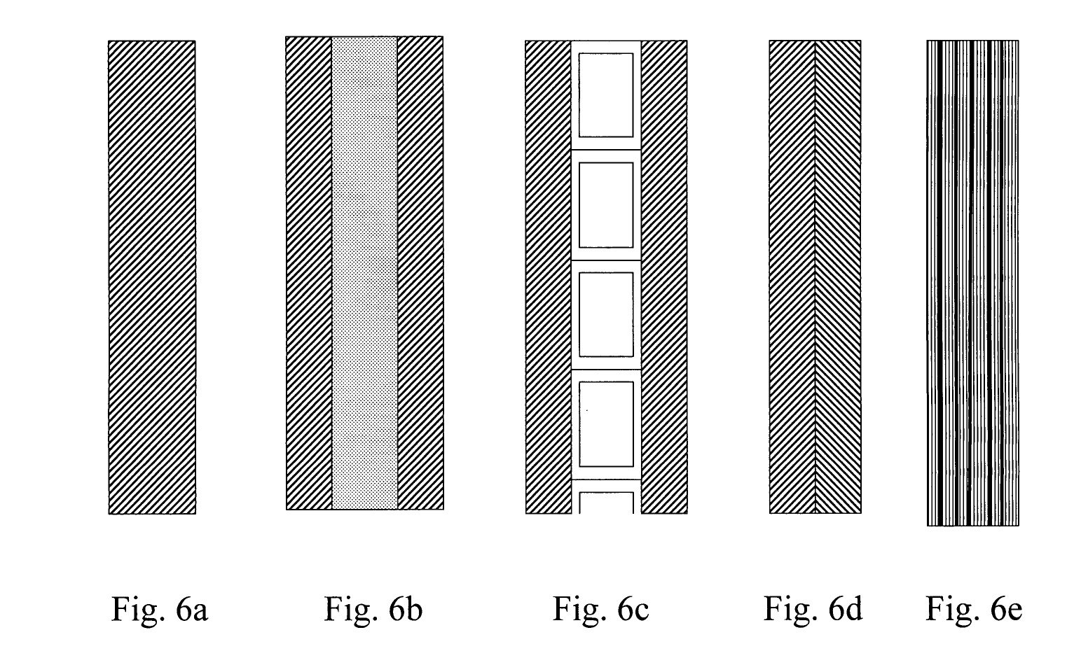

Although the composite must be used to obtain the required amount of breach resistance per unit thickness in the vicinity of the impact location, it may be advantageous to have other materials in the section as well, particularly in areas of low stress. Other materials may be useful to provide additional benefit beyond breach resistance. Such benefits include acoustic control, outer appearance, or firm connection to a different anchoring material. Also some combinations of material provide increased breach resistance, with weight and thickness trade-offs. FIG. 6a shows the simplest case in which the barrier is a composite laminate where each ply is the same material. As shown in FIG. 6b, the barrier may be of sandwich construction, where at least one layer is the composite and at least one layer is a core material. The core materials in the sandwich may include but not be limited to, opened or closed cell foam, aluminum honeycomb, nomex, embedded I-beams of varying materials, or as shown in 6c, embedded composite pultrusions of constant cross-section along the length of the pultrusion. FIG. 6d shows the barrier as a hybrid laminate, where a portion of the laminate total thickness uses one type of composite laminate and the other portion of the thickness uses a different type of composite laminate. In 6e the barrier is a hybrid laminate utilizing different composite material plies or layers from one layer to the next in an inter-leaved fashion.

Moreover, the thickness of the section is determined by the maximum design load at the point of greatest load, typically ground level, or point of impact. Away from the area of maximum load, the section b may be made thinner, to reduce weight, or assume functional shapes, such as anti-climb functionality.

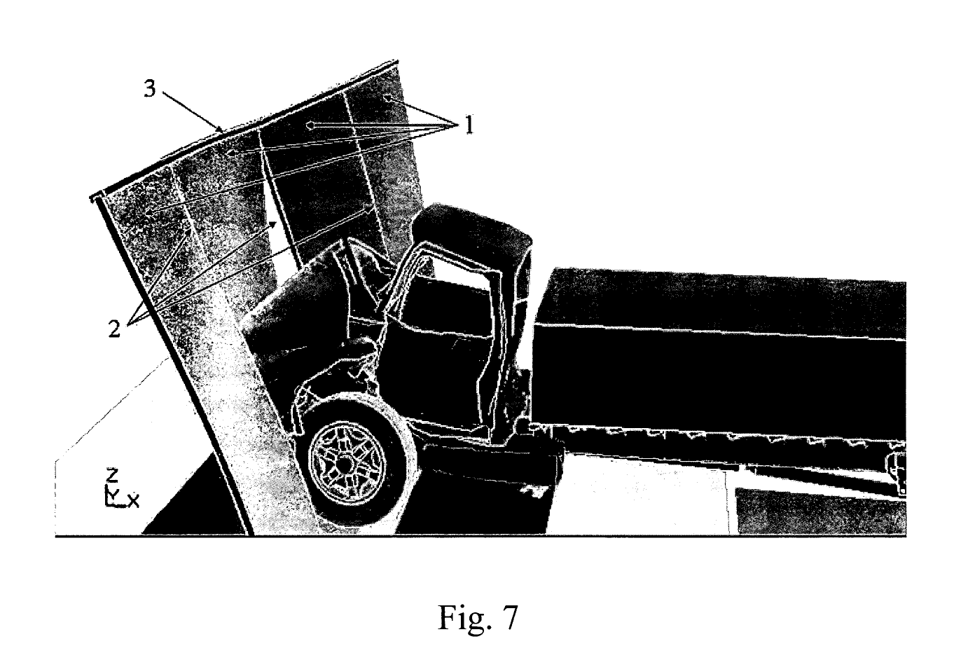

FIG. 7 shows how panels are installed in the field. Barrier panels 1 may typically be fabricated in transportable widths of 8 ft (2.438 m) and any arbitrary height. Panels may be installed in the field by butting vertical panel edges together leaving an unjoined vertical slit 15 between each panel. Panels are aligned and connected by installing a cap 16 along the top of the wall which serves to transfer load from an impacted panel (or panels) to neighboring panels as illustrated in FIG. 7. Panel sections may or may not be connected along vertical seam created by the butting-up of adjacent panels. Where no vertical joint exists between panels, load is transferred from one panel to an adjacent panel via a continuous top cap or continuous horizontal beam attached to the vertical composite wall at a specified elevation which is located at least 34 inches (0.864 m) above ground.

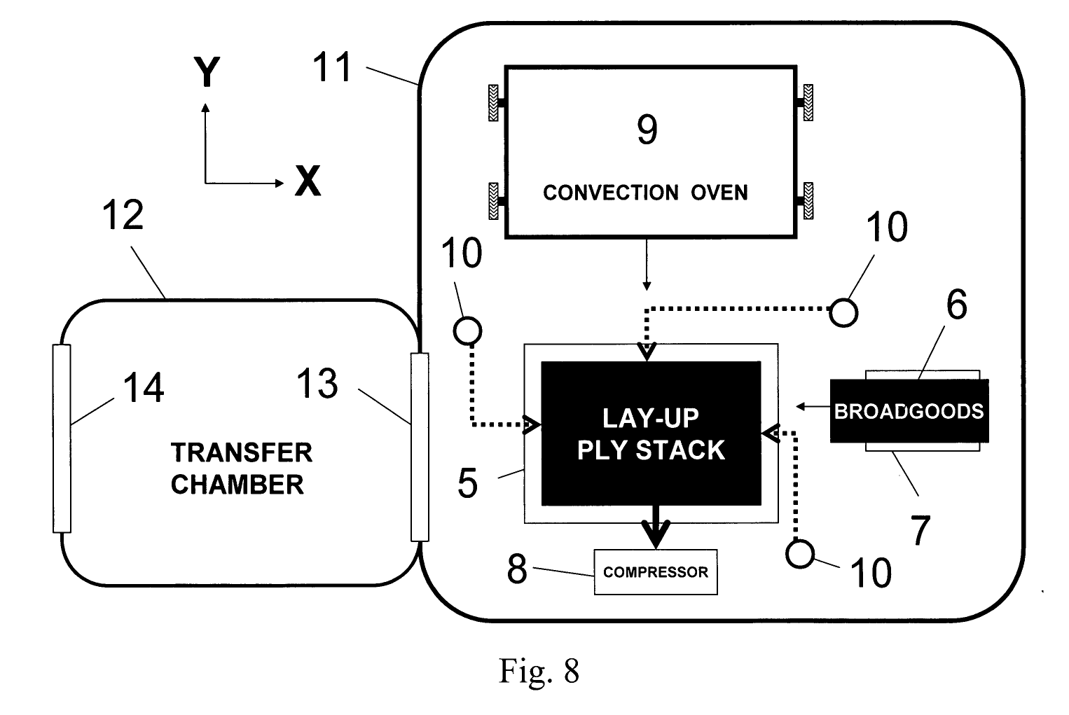

A particularly useful aspect of the invention is the lightweight nature of the material and the relative ease with which segments may be fabricated and handled, even permitting on-site construction of barrier segments. If, for example, it is desirable to retrofit an installation in a remote location, such as a military base in the Middle East, it may be more convenient to ship barrels of resin and rolls of reinforcement than to ship hundreds of 8 ft (2.44 m) wide, 1.15 ton, prefabricated sections. As long as a semi-controlled environment can be created and a forming tool available, the barrier sections may be easily fabricated and assembled on-site. An example of an on-site fabrication facility is shown in FIG. 8. The elements shown in FIG. 8 must be in a relatively clean, air conditioned, temperature and humidity controlled environment. The inventor contemplates housing the facility in an enclosure, such as an air filled, positive pressure, fabrication tent. The elements include 5, a stationary lay-up tool. Broadgoods 6 are unrolled from the payout drum 7 and deposited on the lay-up tool, 5. The payout drum moves back and forth in the y direction to deposit broadgoods along the entire length of the lay-up tool, 5. A Compressor 8 draws approximately one Atmosphere of vacuum for ply stack debulking (i.e. consolidation of stacked plies). The Compressor is also used for Resin Infusion if the Tool is stacked with dry Broadgoods rather than prepreg. The optional Convection Oven 9 (not required for ambient curing) rolls in the Y direction and can be raised and lowered over and onto the stationary Tool when elevated temperature curing is necessary for Laminate Curing when Prepreg Broadgoods are used. The Oven consists of five insulated walls and a heater with a recirculating forced air blower. Resin drums and infusion lines 10 facilitate the resin infusion of the dry stack of Broadgoods. The facility may be housed in an inflatable, positive pressure, air conditioned Tent 11 with temperature and humidity control. A Positive Pressure Transfer chamber 12 is used to prevent loss of positive pressure in the fabrication Tent when removing the cured part from the Tent. After the cured part is moved into the pressurized transfer chamber, the Passageway 13 is sealed to prevent loss of pressure in the fabrication Tent. Only after sealing Passageway 13 is the Transfer Chamber Exit 14 allowed to be opened.

The facility may include a vacuum assisted resin infusion capability. The vacuum being drawn on the bag sucks air out of the bag while sucking resin into the bag and simultaneously serves to consolidate the layers of reinforcement. Curing may also be accomplished at ambient temperature without an oven by mixing appropriate amounts of catalyst and/or promoter into the resin to initiate a timed exothermic reaction which cures the consolidated stack of plies at the temperature developed by the exotherm. Alternatively, a pre-impregnation technique is also possible. In a further embodiment of the method, the reinforcing fiber is pre-impregnated (commonly referred to as prepreg) with partially cured (i.e. B-staged) resin while still in broadgoods tape or woven fabric form. As mentioned previously, the resin content, R, of the pre-preg shall be in the range 31%±4% by weight in order to fabricate a breach resistant, structural laminate exhibiting optimal flexural strength. A release film is applied to the prepreg broadgoods which is peeled off prior to the stacking of prepreg layers onto the Tool or mold. The prepreg stack is intermittently consolidated (i.e. debulked) by vacuum bagging until the required number of plies are deposited onto the Tool. The ply stack is vacuum bagged and oven cured to net thickness. This approach eliminates the need for using wet resin during the fabrication of barrier segments. The sections may be produced and cured in the on-site fabrication tent and moved and installed easily by a small work crew.

The invention, with possible smaller sections, is equally applicable to other targets, such as guard posts and check points. In fact any site, subject to ground level battering ram type of breaching threats could be quickly and easily protected by the invention.

We claim:

1. a breach protection barrier, comprising:
an above ground portion constructed entirely or in part of a panels made of an FRP thick laminate, fabricated using the Vacuum Infusion Process, the laminate characterized by:
the laminate thickness resulting from a plurality of plies,
a resin content of at least 28% by weight; and,
greater than 25% of the fibers oriented in the height direction and greater than 25% oriented in the width direction, with the orientations maintained in each ply of the laminate.

2. The breach resistant barrier of claim 1 further comprising external bracing, including angular bracing, linear bracing or both.

3. The breach resistant barrier of claim 1 further comprising a below ground portion which anchors the barrier.

4. The breach resistant barrier of claim 3 wherein the below ground portion ≦2 ft (0.608 m) in depth, resulting in a semi-portable, low soil embedment solution.

5. The breach resistant barrier of claim 1 wherein the barrier is anchored above ground, resulting in a completely portable, no soil embedment solution.

6. The breach resistant barrier of claim 1 wherein the composite material is a fiber reinforcement in a polymer resin matrix.

7. The polymer resin matrix of claim 6 wherein the polymer resin matrix is resistant to galvanic corrosion, solvents and chemical agents and exhibits a high specific strength, high specific modulus, high strain to failure, high fracture toughness and is not hygroscopic.

8. The breach resistant barrier of claim 1 wherein the barrier consists of sectional elements, arranged to form a continuous wall.

9. The breach resistant barrier of claim 8 wherein at least a portion of wall panels are mounted such that a vertical slit is maintained between the panels.

10. The breach resistant barrier of claim 9 wherein the wall panels are connected along the top edge of the wall by a continuous top cap longer than the width of a single panel, wherein the cap serves to align neighboring panels and to distribute load to adjacent panels along the length of the wall.

11. The breach resistant barrier of claim 7 wherein the sectional elements may be colored to provide aesthetic and architectural value.

12. The breach resistant barrier of claim 1 wherein the barrier is a sandwich construction, of which at least one layer is the composite laminate and at least one layer is a core material.

13. The breach resistant barrier of claim 12 wherein the type of core material includes; an opened cell foam, a closed cell foam, a honeycomb material, nomex, embedded I-beams, embedded composite pultrusions or metal extrusions.

14. The breach resistant barrier of claim 1 wherein the barrier is a composite laminate made from several layers or plies which make up the entire barrier thickness.

15. The breach resistant barrier of claim 14 wherein the layers are oriented at different angles with respect to one another.

16. The breach resistant barrier of claim 14, wherein each layer may utilize different fiber architectures, including woven fabric, unidirectional tape, stitched reinforcement, or knitted reinforcement.

17. The breach resistant barrier of claim 1 wherein the barrier is a hybrid laminate where part of the laminate total thickness uses one type of composite laminate and the other part of the thickness uses a different type of composite laminate.

18. The breach resistant barrier of claim 1 wherein the barrier is a hybrid laminate utilizing different composite material plies or layers from one layer to the next in an inter-leaved fashion.

19. A method of constructing a breach resistant barrier on site, comprising:
Providing a controlled environment at or near the barrier installation site,
providing a tool which allows for forming of barrier sections, fabricating and curing sections in the controlled environment; and,
using the sections produced in the controlled environment to form a barrier pattern.

20. The method of claim 19 wherein the tool can be modified on-site to make varying shapes of barrier sections.

21. The method of claim 19 wherein the controlled environment is an air conditioned enclosure in which at least temperature and humidity are controlled.

22. The method of claim 19 wherein the sections are constructed at least in part using a fiber reinforced, polymer resin matrix, composite where the cured resin content is 31%±4% by weight.

23. The method of claim 22 wherein resin is introduced using a vacuum infusion.

24. The method of claim 22 wherein resin is applied by pre-impregnating the reinforcement fabric broadgoods prior to the stacking of said.
